(19) United States
(12) Patent Application Publication
(10) Pub. No.: US 2019/0040925 A1
(43) Pub. Date: Feb. 7, 2019

(54) Piston-Cylinder Unit

(71) Applicant: ZF FRIEDRICHSHAFEN AG, Friedrichshafen (DE)

(72) Inventors: Andreas ALZER, Eitorf (DE); Redolf SCHULTE, Hennef (DE)

(21) Appl. No.: 16/076,969

(22) PCT Filed: Jan. 9, 2017
(86) PCT No.: PCT/EP2017/050293

§ 371 Date: Aug. 9, 2018

(30) Foreign Application Priority Data
Feb. 10, 2016 (DE) 10 2016 202 007.2

(51) Int. Cl. F16F 9/48; F16F 9/32; F16J 9/12; F16F 9/36

(52) U.S. Cl. CPC F16F 9/483; F16F 9/3235; F16F 2230/30; F16F 9/368; F16F 2224/0208; F16J 9/12

(57) ABSTRACT

A piston-cylinder unit has a piston rod at which is arranged at least one piston which has at an outer lateral surface a radially elastic piston ring that moves into a cylinder depending on a stroke position of the piston rod and has a smaller diameter than in a stroke position in which the piston is located outside of the cylinder. The piston ring has a stop that defines a maximum diameter of the piston ring.

### CROSS REFERENCE TO RELATED APPLICATIONS

This is a U.S. national stage of application No. PCT/EP2017/050293, filed on Jan. 9, 2017. Priority is claimed on German Application No. DE102016202007.2, filed Feb. 10, 2016, the content of which is incorporated herein by reference.

### BACKGROUND OF THE INVENTION

### 1. Field of the Invention

The invention is directed to a piston-cylinder unit.

### 2. Description of the Prior Art

A piston-cylinder unit is known, for example, from U.S. Pat. No. 3,175,645. This piston-cylinder unit has a piston fastened to a piston rod moves into a cylinder after a defined stroke position. In this variant, the cylinder is formed by a cap-shaped component part which is fixed in an outer cylinder. However, it is also known to form the cap-shaped component part alternatively by a longitudinal portion with a reduced diameter of the outer cylinder.

Regardless of the shape of the cylinder, the piston is sealed relative to the inner cylinder wall by a piston ring within an outer lateral surface of the piston. The piston ring is radially preloaded.

When the piston is located outside of the cylinder, the piston ring enlarges radially. With each penetration into the cylinder, the piston ring must be reduced again to its preloading dimensions or to the diameter of the inner wall. A run-in bevel shown at the cap-shaped component part below the piston rod guide in U.S. Pat. No. 3,175,645 is often available for this purpose.

The radial compression during penetration causes rapid wear on the piston ring. DE 34 13 927 A1 discloses a piston ring for a piston-cylinder unit in the basic constructional form shown in U.S. Pat. No. 3,175,645, which is formed of a comparatively hard material and has a slit so that it can enlarge radially elastically. A preloading ring which provides for a radial enlarging of the piston ring is inserted between a piston ring groove and the piston ring.

However, a disadvantage in a piston ring of this type consists in that a noticeable impact noise occurs when the piston ring penetrates into the reduced inner diameter. There is also considerable wear in spite of the hard material.

### SUMMARY OF THE INVENTION

It is an object of the present invention to solve the problems known from the prior art in a simple manner in that the piston ring has a stop that defines a maximum diameter of the piston ring.

The maximum outer diameter of the piston ring, which is defined under all operating circumstances, ensures that the piston ring enters the cylinder noiselessly and does not to damage the material. The outer diameter of the piston ring can be adapted to the cylinder in a comparatively very precise manner so that the reduction in radial diameter when penetrating into the cylinder can be small.

The stop is preferably formed by an outer sleeve. The piston ring could also be secured against excessive widening, e.g., also with a snap-in connection in an abutment area, but this construction does not permit the required accuracy in diameter and is not as durable.

In a further configuration, the piston ring has an outer annular groove for receiving the sleeve. Accordingly, the piston ring is shaped in a defined manner over a large circumferential area so that, e.g., the criterion concerning the roundness of the piston ring can also easily be adhered to.

According to an advantageous aspect of the invention, with a minimum outer diameter, the piston ring has a radial clearance with respect to a groove base of a piston ring groove. Accordingly, the piston ring can be displaced slightly radially relative to the piston. This characteristic is particularly advantageous when the piston-cylinder unit has two pistons at the piston rod, and a radial overdetermination of the guiding of the piston in the cylinder can be compensated in this way.

It is provided that the sleeve has a radial clearance relative to the cylinder. In this way, a material and a geometry can be used that is designed exclusively for the stop function but which need not undertake a sealing function.

A sleeve which is formed by an O-ring has turned out to be one possible economical variant. An O-ring is a comparatively simple and advantageous component part.

Alternatively, the sleeve is formed by a metal clamping ring. The clamping ring can be constructed, e.g., as a snap ring, known per se, in accordance with DIN 7993. The advantage of a metal clamping ring consists in that the thermal expansion behavior of the clamping ring is very similar to that of the cylinder.

In one configuration, the piston ring has two sealing webs that are spaced apart axially. The advantage of this construction is that the installation position of the piston has no influence on function because the piston ring can have a symmetrical construction.

With regard to ease of assembly, it has been shown to be particularly advantageous when the annular groove separates a sealing web and a holding web. The holding web has a smaller outer diameter than the sealing web. The sealing web requires a cross section that is optimized for the sealing function. However, the sleeve can have a very flat cross section so that the depth of the annular groove could be comparatively small to secure the sleeve axially. Consequently, it is useful to form the holding web with a smaller diameter so that the sleeve need not be clamped to such a great extent for assembly.

An area of the piston ring located outside of a piston ring groove is connected to an inner through-opening of the piston ring via at least one radial opening so that no pressure pockets occur inside of the piston ring. An additional radial enlarging force caused by damping medium is extensively compensated in this way.

This effect is reinforced when at least one axial cover side of the piston ring has at least one transverse channel that connects an inner through-opening to an outer lateral surface of the piston ring. Further, this minimizes the friction between the piston ring groove and the piston ring so as to optimize the ability of the piston ring to displace radially relative to the piston.

### BRIEF DESCRIPTION OF THE DRAWINGS

The invention will be described more fully with reference to the following description of the figures.

The drawings show:

FIG. 1 is a piston-cylinder unit in a sectional view;

FIG. 2 is a detailed view of a piston according to FIG. 1; and

FIG. 3 is an alternative variant of the piston ring according to FIG. 2.

### DETAILED DESCRIPTION OF THE PRESENTLY PREFERRED EMBODIMENTS

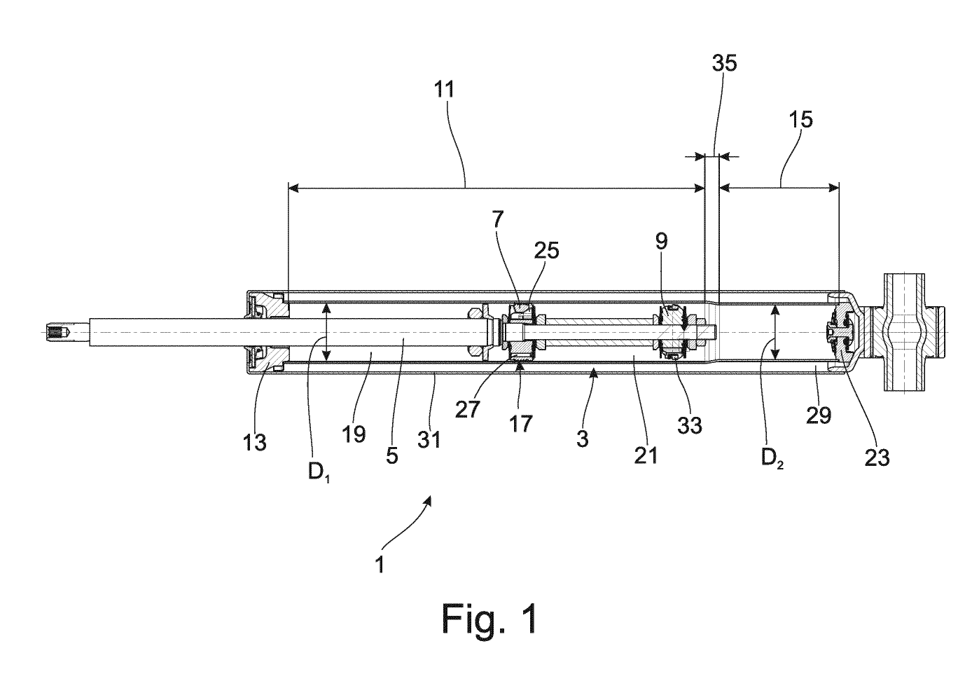

FIG. 1 shows a possible embodiment form of a piston-cylinder unit 1 according to the invention. A piston rod 5 is axially displaceably supported in a cylinder 3. A first piston 7 and a second piston 9 at an axial distance from the latter are arranged at the piston rod 5. As a rule, the two pistons 7; 9 are rigidly arranged. However, the invention can also be used when one or both pistons 7; 9 are mounted so as to be moveable within limits relative to the piston rod 5.

Cylinder 3 comprises a first longitudinal portion 11 with a first diameter D1. In this embodiment example, this longitudinal portion 11 is closed at the end by a piston rod guide 13. Adjoining at the opposite end is a second longitudinal portion 15 with a second diameter D2, where the second diameter D2 is smaller than the first diameter D1.

The two pistons 7; 9 also have a different nominal diameter. The first piston 7 is adapted to the larger diameter D1 of the first longitudinal portion 11 of cylinder 3 and has a piston ring 17 that separates a first work space 19 in direction of the piston rod guide 13 from a second work space 21 on the tenon side between the first piston 7 and a base 23 of the second longitudinal portion 15. The separation is not hermetically tight but is defined by two damping valves 25; 27 that allow flow alternately. Serving as base 23 in this embodiment example is a bottom valve with an alternating through-flow with respect to an annular compensation space 29 between the cylinder 3 and an outer receptacle tube 31. The entire cylinder 3 is completely filled with a damping medium.

The second piston 9 is adapted to the second diameter D2 of the second longitudinal portion 15 and is therefore smaller than the first piston 7.

FIG. 1 shows the piston-cylinder unit 1 in a defined position in which the first piston 7 sealingly slides in the first longitudinal portion 11 and the damping valves 25; 27 generate a damping force in the first piston 7. The second piston 9 is also located in the first longitudinal portion 11, but damping medium flows around it because a piston ring 33 of the second piston 9 does not have a sealing contact with respect to the inner wall of the first longitudinal portion 11. Consequently, the second piston 9 cannot generate significant damping force due to the open annular gap.

When the second piston 9 moves into the second longitudinal portion 15 during a corresponding stroke movement of the piston rod 5, the piston ring 33 contacts the inner wall of the second longitudinal portion 15 so that the second piston 9 also generates a damping force with its damping valves, which is added to the damping force of the first piston 7.

In this embodiment example, the second longitudinal portion 15 is formed by cylinder 3. However, it would also be possible for an open cap which faces in direction of the second piston 9 and has a smaller inner diameter D2 than the first longitudinal portion to be fastened, e.g., to the base 23.

When entering the second longitudinal portion 15, the piston ring 33 of the second piston 9 is slightly elastically reduced in diameter such that the piston ring 33 contacts the inner wall of the second longitudinal portion 15 accompanied by radial preloading. For a smooth transition and entry of the second piston 9 or piston ring 33 into the second longitudinal portion 15, a conical transition 35 is formed between the first longitudinal portion 11 and the second longitudinal portion 15 of cylinder 3.

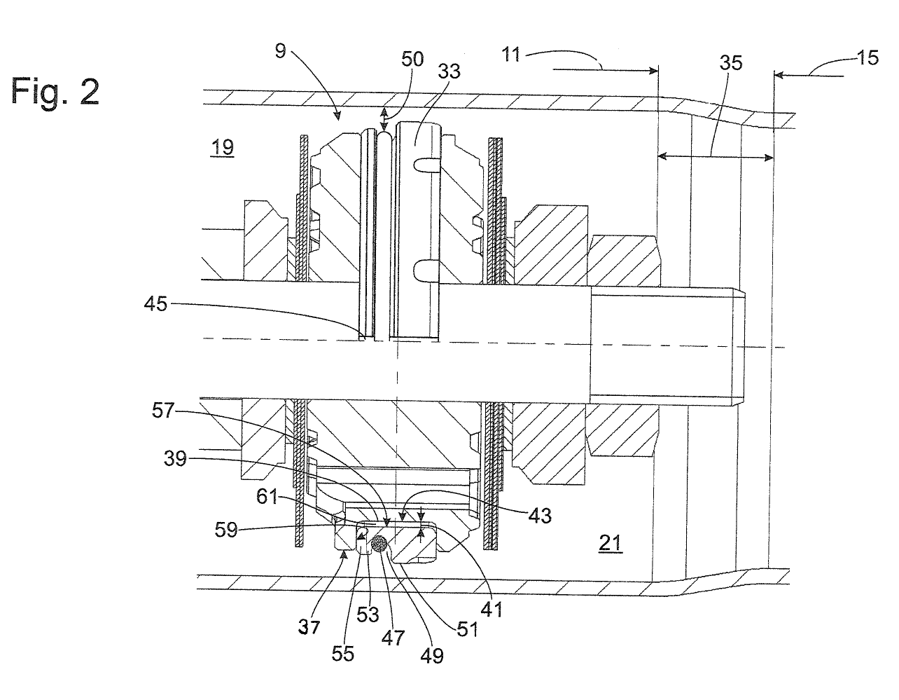

FIG. 2 shows the second piston 9 at the transition 35 between the first longitudinal portion 11 and the second longitudinal portion 15 of the cylinder. A piston ring groove 39 in an outer lateral surface 37 of the second piston 9 serves to receive the piston ring 33. As can be seen from FIG. 2, piston ring 33 has a radial clearance 41 relative to a groove base 43 of the piston ring groove 39. A radial clearance is also maintained when the piston ring 33 moves into the second longitudinal portion 15. A slight angular offset between the first piston 7 and the second piston 9 can be compensated by the radial clearance 41 without the piston ring 33 of the second piston 9 having to be radially preloaded more heavily on one side.

Piston ring 33 has a radially extending slit 45 so that piston ring 33 is radially elastically deformable. In the relaxed state of the piston ring 33, the diameter of the piston ring 33 is somewhat greater than the diameter D2 of the inner wall of the second longitudinal portion 15. A stop 47 limits the extent of radial enlargement of the piston ring 33. The stop 47 is formed by a sleeve which is separate from the piston ring 33.

The piston ring 33 further has an outer annular groove 49 which receives the sleeve 47. Therefore, the piston ring 33 also has a U-shaped cross section. It will also be seen that the sleeve 47 is guided into the annular groove 49 deeply enough that, in principle, there is a radial clearance 50 with respect to the inner wall of cylinder 3. The sleeve 47 does not take over a sealing function. For that purpose, there is a sealing web 51, which is separated from a holding web 53 via the annular groove 49. The holding web 53 has a smaller outer diameter than the sealing web 51 so that the sleeve 47 is easy to assemble, particularly when it is formed by a metal clamping ring, since a smaller radial enlargement is needed when slipping over the holding ring than if holding web 53 and sealing web 51 had the same outer diameter.

Further, the figure shows that an area of the piston ring 33 located outside of the piston ring groove 39, e.g., an outer lateral surface 63, is connected to an inner through-opening 57 of piston ring 33 via at least one radial opening 55. The radial opening 55 can be formed, e.g., by the annular groove 49, the holding web 53 or sealing web 51 but can also be formed as a transverse channel in a cover side 59 of the piston ring 33. In this way, damping medium present inside the annular chamber 61 between the through-opening 57 of piston ring 33 and the piston ring groove 39 can flow out of the annular space 61, e.g., when the second piston 9 enters the second longitudinal portion 15 and the annular space 61 is consequently reduced, and is not blocked in any case. In principle, the piston ring 33 could also be elastic such that this reduction in volume would also be compensated by the piston ring 33. However, restrictions in the choice of material would then possibly have to be taken into account.

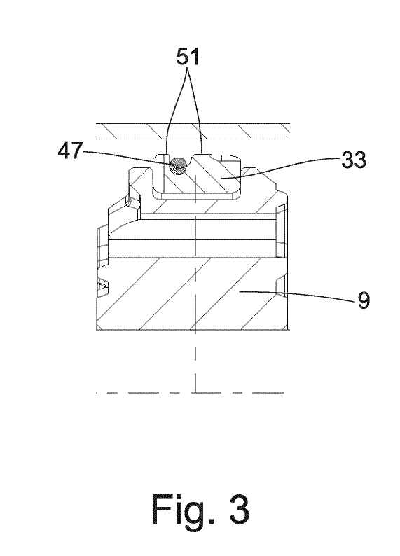

FIG. 3 shows an embodiment in which the holding web 53 and the sealing web 51 have an identical outer diameter. Consequently, the holding web 53 can also be configured as a sealing web 51. A simple O-ring which can be fitted more easily over a larger diameter can be used as sleeve 47. In this variant, the installation position of the piston ring 33 plays no part because the piston ring 33 is constructed symmetrical to the transverse axis. It has been shown in the variant according to FIG. 2 that the above-mentioned installation position is preferable.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A piston-cylinder unit comprising:
a cylinder having a first portion having a first diameter and a second portion having a second diameter that is smaller than the first diameter;
at least one piston having a piston ring that is radially elastic and has at an outer lateral surface;
a piston rod at which the at least one piston is arranged;
a radially elastic piston ring arranged at the outer lateral surface of the piston ring and configured to move into the first portion of the cylinder and the second portion of the cylinder depending on a stroke position of the piston rod and having a smaller diameter in the second portion of the cylinder than in the first portion of the cylinder; and
a stop that defines a maximum diameter of the piston ring.

13. The piston-cylinder unit according to claim 12, wherein the stop is formed by an outer sleeve.

14. The piston-cylinder unit according to claim 13, wherein the piston ring has an outer annular groove configured to receive the outer sleeve.

15. The piston-cylinder unit according to claim 12, wherein the piston ring has a minimum outer diameter and a radial clearance with respect to a groove base of a piston ring groove.

16. The piston-cylinder unit according to claim 13, wherein the outer sleeve has a radial clearance relative to the cylinder.

17. The piston-cylinder unit according to claim 13, wherein the outer sleeve is formed by an O-ring.

18. The piston-cylinder unit according to claim 13, wherein the outer sleeve is formed by a metal clamping ring.

19. The piston-cylinder unit according to claim 14, wherein the piston ring has two sealing webs which are spaced apart axially.

20. The piston-cylinder unit according to claim 14, wherein the outer annular groove separates a sealing web and a holding web, wherein the holding web has a smaller outer diameter than the sealing web.

21. The piston-cylinder unit according to claim 12, wherein an area of the piston ring located outside of a piston ring groove is connected to an inner through-opening of the piston ring via at least one radial opening.

22. The piston-cylinder unit according to claim 21, wherein at least one axial cover side of the piston ring has at least one transverse channel configured as the at least one radial opening which connects the inner through-opening to an outer lateral surface of the piston ring.
